(19) United States
(12) Patent Application Publication
(10) Pub. No.: US 2017/0243143 A1
(43) Pub. Date: Aug. 24, 2017

(54) ESTIMATING COMPLEX WORKFLOW RESULTS USING REPRESENTATIVE DATA POINTS AND WORKFLOW EXECUTION HISTORY

(71) Applicant: INTUIT INC., Mountain View, CA (US)

(72) Inventors: Garron A. ENGSTROM, San Diego, CA (US); Timothy MUELLER, San Diego, CA (US); Jeremy BOWEN, San Diego, CA (US); Massimo MASCARO, San Diego, CA (US); Sasha PEREZ, San Diego, CA (US); Alexander ADAM, San Diego, CA (US); Peter OUYANG, San Diego, CA (US)

(21) Appl. No.: 15/049,982

(22) Filed: Feb. 22, 2016

(51) Int. Cl. G06Q 10/06; G06F 17/30

(52) U.S. Cl. CPC G06Q 10/0633; G06F 17/30424

(57) ABSTRACT

The present disclosure relates to generating estimated results of an interactive workflow based on user input of one or more representative data points and results of the interactive workflow for other users. According to one embodiment, a workflow processing system receives a request to estimate a result expected to be obtained by a first user in completing the interactive workflow and receives one or more representative data points characterizing the first user. The workflow processing system determines an estimate of the result expected to be obtained by a first user in completing the interactive workflow based on the representative data points and an analysis of results of the interactive workflow obtained by a plurality of second users in completing the interactive workflow, wherein each of the plurality of second users share the representative data points characterizing the first user.

### BACKGROUND

### Field

Embodiments presented herein generally relate to computer systems and software. More specifically, embodiments presented herein relate to software used to estimate results of a complex, interactive workflow using representative data points and workflow execution history.

### Description of the Related Art

Many service providers have published online interactive workflows which users may complete to generate a variety of information or perform specific transactions. For example, a complex interactive workflow may allow a user to prepare and file an income tax return, obtain an insurance quote, or calculate interest rates and payments for financing transactions such as automobile loans or home mortgages. These workflows generally request a variety of personal information to generate the result of the complex interactive workflow. For example, a tax preparation service may request a user's address, social security number, income and deduction information, and so on. In another example, a motor vehicle insurance system may request a user's driver's license number, date of birth, address, and vehicle identification numbers, and so on.

Completing online workflows such as these can require substantial time and effort from the users before any results of the workflow are available. That is, a user may have to spend a substantial amount of time progressing through a workflow before receiving an indication of what results they should expect to obtain. For example, a tax preparation workflow may take a few hours to complete, including time to gather and import relevant documents to complete a return. Thus, while the user may desire to know (or at least have some expectation) about what sort of refund or liability they should anticipate, it may not be available until they have completed substantial portions of the tax preparation workflow.

Some workflows may request personally identifying information (e.g., a social security number, driver's license number, date of birth, and so on) in order to generate a result, such as a refund or liability amount in a tax preparation workflow. Some users may be unwilling to provide personally identifying information to an interactive online service without knowing (or at least having some reasonable expectations) about what results they should anticipate.

### SUMMARY

One embodiment of the present disclosure includes a method for estimating results of an interactive workflow based on representative data inputs and historical data. The method generally includes receiving a request to estimate a result expected to be obtained by a first user in completing the interactive workflow and receiving one or more representative data points characterizing the first user. The workflow processing system determines an estimate of the result expected to be obtained by a first user in completing the interactive workflow based on the representative data points and an analysis of results of the interactive workflow obtained by a plurality of second users in completing the interactive workflow, wherein each of the plurality of second users share the representative data points characterizing the first user.

Another embodiment provides a computer-readable storage medium having instructions, which, when executed on a processor, performs an operation for estimating results of an interactive workflow based on representative data inputs and historical data. The operation generally includes receiving a request to estimate a result expected to be obtained by a first user in completing the interactive workflow and receiving one or more representative data points characterizing the first user. The workflow processing system determines an estimate of the result expected to be obtained by a first user in completing the interactive workflow based on the representative data points and an analysis of results of the interactive workflow obtained by a plurality of second users in completing the interactive workflow, wherein each of the plurality of second users share the representative data points characterizing the first user.

Still another embodiment of the present invention includes a processor and a memory storing a program, which, when executed on the processor, performs an operation for estimating results of an interactive workflow based on representative data inputs and historical data. The operation generally includes receiving a request to estimate a result expected to be obtained by a first user in completing the interactive workflow and receiving one or more representative data points characterizing the first user. The workflow processing system determines an estimate of the result expected to be obtained by a first user in completing the interactive workflow based on the representative data points and an analysis of results of the interactive workflow obtained by a plurality of second users in completing the interactive workflow, wherein each of the plurality of second users share the representative data points characterizing the first user.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates an example computing environment, according to one embodiment.

FIG. 2 illustrates an example of a complete interactive workflow and a corresponding estimation workflow, according to one embodiment.

FIG. 3 illustrates an example data matching component, according to one embodiment.

FIG. 4 illustrates a method for switching between a complete interactive workflow and an estimation workflow, according to one embodiment.

FIG. 5 illustrates a method for estimating results for a complete interactive workflow using a set of representative data points and prior workflow results, according to one embodiment.

FIG. 6 illustrates a method to use data provided to the complex interactive workflow to refine an estimate of workflow results, according to one embodiment.

FIG. 7 illustrates example operations that may be performed to refine the estimated results for a full interactive workflow using additional data elements, according to one embodiment.

FIGS. 8A-8D illustrate an example user interface sequence for generating a tax refund estimate based on a set of representative data points, according to one embodiment.

FIG. 9 illustrates an example computing system for estimating the results of a complex interactive workflow using a set of representative data and results of the complex interactive workflow workflows, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Users who are interested, but not committed, to using a given complex interactive workflow (e.g., to prepare a tax return) may be unable or unwilling to immediately provide some information needed by the complex interactive workflow. Users may also desire some assurance that the complex interactive workflow can generate similar or better results than other services before committing the time and effort to use the a given service to obtain a result (e.g., a prepared tax return or a motor vehicle insurance quote). For example, a user trying to obtain an estimate for car insurance premiums may not have immediate access or knowledge of the vehicle identification numbers for a given vehicle. In another example, a user trying to obtain an estimate of tax refund or liability amounts may not have immediate access to pertinent documents (e.g., W-2 or other earned income forms, qualified dividend information, mortgage interest statements, and so on).

Embodiments presented herein provide techniques for estimating certain result of a complex interactive workflow using (i) a set of representative data points provided by a given user and (ii) historical data from the complex interactive workflow. By using a set of representative data points and historical data from the complex interactive workflow, an analysis system can estimate what result a user should expect after completing the complex interactive workflow. Providing an estimate up front may help persuade a user that it is worth their time and effort to complete the full workflow. The analysis system can identify other characteristics that may improve the accuracy of the estimated result of the complex interactive workflow. Additionally, the analysis system can use the representative data points to estimate a variety of data values that influence the overall results of the complex interactive workflow (e.g., estimate what tax credits an individual may qualify for).

By estimating aspects of the results of a complex interactive workflow using representative data points about a given user and historical results of the complex interactive workflow obtained by other users, an analysis system can encourage a user to continue (or initiate) the complex interactive workflow. For example, as discussed above, the estimated amount of a tax return may demonstrate, to the user, that the complex interactive workflow can generate a result that is comparable to the results expected by the user.

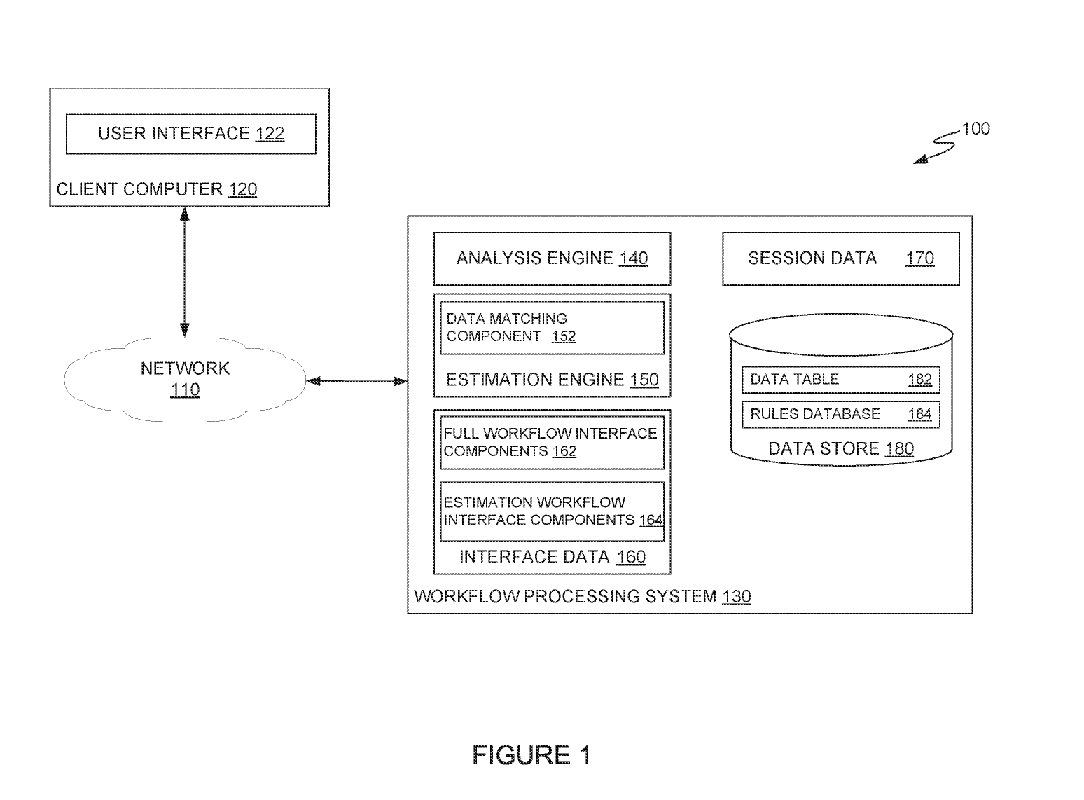

FIG. 1 illustrates an example computing environment 100 for estimating results of a complex interactive workflow, according to one embodiment. As illustrated, computing environment 100 includes a client computer 120 and a workflow processing system 130, connected via network 110.

As illustrated, client computer 120 includes a user interface 122 through which a user can invoke both a complex interactive workflow and a related estimate workflow, as described in further detail below. User interface 122 generally displays elements of the full workflow interface components 162 while a user interacts with the complex interactive workflow or elements of the estimation workflow interface components 164 while the user interacts with the estimation workflow. A user can switch from the full workflow displayed using full workflow interface components 162 to the estimation workflow displayed using estimation workflow interface components 164, for example, by clicking a button to switch from an interface of the full workflow or by omitting certain information while the user interacts with the full workflow (e.g., by attempting to proceed with the full workflow after omitting certain income data in a tax return preparation workflow). In other words, a complex interactive workflow can switch from presenting the complex interactive workflow to the estimation workflow based on the absence of user input for certain fields required to complete the complex interactive workflow,. Provided the user interacts with the estimation workflow and is presented with an estimate of the results of the complex interactive workflow, the workflow processing system can prompt the user to return to the complex interactive workflow. That is, the workflow processing system can use the results of the estimation workflow to encourage a user to complete the complex interactive workflow.

User interface 122 generally provides an interface to the workflow processing system which allows a user to complete all the steps of the complex interactive workflow required in a given case (e.g., to prepare and file a complete tax return or obtain an insurance quote). After completing the complex interactive workflow, user interface 122 may provide the user with the work product or results generated by the full interactive workflow, e.g., a tax return which can be submitted to the appropriate taxation authorities.

The estimation workflow is generally configured to provide an estimate of certain results of a corresponding complex interactive workflow. To do so, in one embodiment, a user interface 122 generated from estimation workflow interface components 164 may prompt a user to provide a set of representative data points about that user. In some cases, for example, the interface components 162 may include drop-down boxes or other input fields that a user can interact with using a mouse or touch screen to specify values for each data point needed to create an estimate.

As shown, workflow processing system 130 generally includes an analysis engine 140, estimation engine 150, interface data 160, session data 170, and data store 180. If a user provides data to workflow processing system 130 via full workflow interface components 162, the analysis engine 140 may process data provided by the user and guide the user through the complete workflow process. Once complete, the analysis engine 140 may generate a result (e.g., a completed tax return). Otherwise, if a user interacts with the estimation workflow components 164, the estimation engine 150 may generate an estimated result for some aspect of the complex interactive workflow based on the user-provided data and historical data from the complex interactive workflow.

In one embodiment, the estimation engine 150 relies on an analysis of a large data set of results of the complex interactive workflow for other users to provide an estimate to a requesting user. The data set of results generated by other users interacting with the workflow may be analyzed to determine expected results of the complex interactive workflow for a group of users having certain characteristics. The estimates may be stored, for example, in a lookup table where each estimate is associated with a set of user characteristics (e.g., in a tax preparation workflow, a lookup table can associate an estimate of a return amount with a particular combination of income range, marital status, and number of dependents). The range is determined based on a distribution of actual return amounts of a population of users sharing these characteristics who prepared a tax return using the complex workflow. As discussed in further detail below, estimation engine 150 can match a user with the estimate based on the representative data points provided by that user.

What representative data points should be used may be determined based on the historical data of other users who have completed the complex interactive workflow. For example, a statistical analysis of the results of the complex interactive workflow for users that have previously completed the workflow (e.g., users who have prepared a tax return in the prior year using the complex interactive workflow) can identify the data points that statistically have the most influence on the results of the complex interactive workflow.

Analysis engine 140 generally performs the complete workflow as data input is received from a client computer 120 and interface components for the appropriate workflow displayed in user interface 122 (e.g., as analysis engine 140 receives all the information needed to prepare a tax return). In some cases, analysis engine 140 may dynamically determine data to request from a user in order to perform the complex interactive workflow based on user input and relevant rules stored in rules database 184 at data store 180. For example, in a tax preparation workflow, analysis engine 140 can determine that a user should be prompted to provide data from a W-2 form if the user indicates that the user has received wage income during the tax year, or that a user should be prompted to provide data from a 1099-DIV form if the user indicates that the user has received dividend income during the tax year. Additionally, analysis engine 140 used in a tax preparation workflow can omit prompts for certain types of data if, based on user input and relevant rules stored in rules database 184, analysis engine 140 determines that a user is not eligible to take a tax credit or deduction. That is, the analysis engine can skip certain sub-workflows that are determined to not be applicable to a given user based prior input from that user. In a motor vehicle insurance workflow, analysis engine 140 can receive personal data about the user (e.g., name, date of birth, driver's license number, and so on), the vehicles to be insured (e.g., make, model, vehicle identification number, and so on), and coverage options to generate an insurance quote for the user.

Analysis engine 140 may use various techniques to determine what questions to present to a user based on user input. Some techniques for doing so are described in U.S. patent application Ser. No. 14/097,057 of Wang et al., filed Dec. 4, 2013 and entitled “Methods, Systems, and Computer Program Products for Applying Generated Rules for Personalized Interview Experience;” U.S. patent application Ser. No. 14/206,834 of Wang et al., filed Mar. 12, 2014 and entitled “Computer Implemented Methods, Systems, and Articles of Manufacture for Suggestion-Based Interview Engine for Tax Return Preparation Application;” and U.S. patent application Ser. No. 14/448,886 of Wang et al., filed Jul. 31, 2014 and entitled “System and Method Representing Tax Rules and Calculations Thereof Using Declarative Data Structures,” each of which are assigned to Intuit Inc. of Mountain View, Calif.

Estimation engine 150 generally receives a set of representative data points from a user via user interface 122 displaying estimation workflow interface components 162 on client computer 120. In one embodiment, the representative data points may be used to estimate what results that a given user should expect after completing the complex interactive workflow.

For example, assume that estimation engine 150 is being used to estimate a tax refund (or liability) amount a given user should expect after a complete tax return is prepared. In such a case, estimation engine 150 may use a small number of representative data points about the user that have a predictive influence on the estimated result of a tax preparation workflow (i.e., an estimated tax refund or payment).

In an example estimation workflow, an estimation engine 150 may receive data indicating a range of income, marriage status, and number of dependents for a user requesting an estimate for the results of a tax preparation workflow. If the user indicates a marital status of “married,” an estimation engine 150 can infer that a user is likely to file using a married filing jointly status. In another example, if a user indicates that the user's marital status is single and the user has a non-zero number of children, estimation engine 150 can infer that the user would have a head of household filing status.

In one embodiment, estimation engine 150 uses the representative data points as a key to search a data table 182 in data store 180. Data table 182, for example, may be structured as a lookup table in which estimate return amounts are associated with specific combinations of values of the representative data points. As noted, each estimate may have been determined by analyzing return amounts of a population of users sharing a set of the same representative data points obtained using the complex interactive workflow. The entries in data table 182 may include, for example, a first estimate range for taxpayers who used the complex interactive workflow to prepare a tax return and have a specific marital status, number of dependents, and income range. Additional entries in data table 182 may include narrower estimate ranges for groups of users with a specific marital status, number of dependents, income range, and ZIP code, users who are home owners in the given locality (i.e., an estimated range of tax refunds for taxpayers who are homeowners in a given locality), and so on.

For example, presume a user indicates that the user is single, has two children, and earns between $45,000 and $50,000. The three representative data points provided by the user can be used to find an entry in the data table associated with those three data points. The corresponding estimate reflected in the appropriate entry in the data table may have been determined from a statistical analysis of similar users who completed the complex interactive workflow (e.g., users who also are single, have two children, and earn between $45,000 and $50,000, and who completed a tax return in the prior tax year using the complex interactive workflow). Additional, narrower estimate ranges may be calculated and included in data table 182 for subsets of a certain groups of users (e.g., users who also are single, have two children, earn between $45,000 and $50,000, and live in a certain ZIP code).

Estimation engine 150 generally includes a data matching component 152. Data matching component 152 generates a query to search a data table 182 in data store 180 for an estimate related to the results of the complex interactive workflow based on the representative data points provided by the user.

In some cases, estimation engine 150 can break down the overall estimated result for the completed workflow into an aggregation of multiple components that contribute to the overall estimated result. The estimated results for the multiple components may be generated from the data set of historical data from other users who have completed the complex interactive workflow. For example, in a tax preparation system, the components of the overall estimated result may include, for example, an estimated range of tax liabilities, based on the income range provided by the user, and estimates of deductions and tax credits users sharing the same representative data points have received. In system used to quote automobile (or other) insurance premiums, the components of the overall estimated result may include, for example, estimated ranges for the cost of liability cover, comprehensive cover, uninsured motorist cover, and so on.

In some cases, a user may request an estimate related to the results of the complex interactive workflow after providing some data to the complex interactive workflow (e.g., after initiating, but prior to completing, the complex interactive workflow). When estimation engine 150 queries a data table 182 for estimated results of the complex interactive workflow, estimation engine 150 can generate a query to search data table 182 in data store 180 for the estimate range associated with the representative data points and the data provided to the complex interactive workflow. For example, if a user provided a ZIP code to the complex interactive workflow before initiating the estimation workflow, estimation engine can query data table 182 for an estimate to return to the user, stored as an entry in a lookup table. The estimate may have been determined for a population of users in the same ZIP code with matching (or substantially matching) incomes, marital status, and number of dependents. By using the data provided to the complex interactive workflow with the representative data points to search for results of the complex, interactive workflow from other users, estimation engine 150 can obtain a more accurate estimate of the results of the complex, interactive workflow.

In some cases, estimation engine 150 can use information provided to workflow processing system 130 before the user requests an estimate to identify additional data points that can be used to refine an estimate provided to the user. For example, if the home address indicates that a user lives in a particular ZIP code, estimation engine 150 can determine (e.g., based on income range information and characteristics of similar taxpayers in the same ZIP code) whether to ask if the user owns a home or has a home mortgage.

The above example in which statistically analyzed estimates are stored in a lookup table generally allows estimation engine 150 to quickly return a reasonably accurate estimated result of the complex interactive workflow. However, in an alternative embodiment, estimation engine 150 can dynamically analyze workflow history to estimate the results of the complex interactive workflow for a given user. In such a case, data table 182 may include the results of the complex interactive workflow for each user that has completed the complex interactive workflow (e.g., generated a tax return using the complex interactive workflow). Each entry may include a number of keys that estimation engine 150 can use to narrow the overall data set to a subset of the relevant data (e.g., all tax returns completed by users who have prepared a tax return using the complex interactive workflow and have a specified income range, marital status, and number of dependents). Using the subset of relevant data, estimation engine 150 can calculate the average result from the data set of matching (or substantially matching) entries from data table 182, as well as the standard deviation from the mean, and generate an estimated result as a range starting at a number of standard deviations below the mean and ending at a number of standard deviations above the mean.

In some cases, estimation engine 150 can determine a confidence level related to the accuracy or probability of the estimated results of the complex, interactive workflow. If, for example, the estimated results have a large range between the low and high ends of the estimate range in order to have confidence in the accuracy of the range, estimation engine 150 can request additional pieces of representative data to refine the estimate (and correspondingly reduce the range over which the calculated estimate should be reasonably accurate). For example, if the high end estimate exceeds the low end estimate by a preset amount, estimation engine 150 can examine the data returned from data table 182 to identify whether an additional data point could narrow the difference between the low and high ends of the estimate range. For example, the data table could contain multiple results for the results for the a primary set of inputs (e.g., income, marital status, and number of dependents in a tax estimation workflow). A first entry could provide an estimate based only on the primary set of inputs. Additional entries in the data table could specify the primary set of inputs, one or more additional input data points (or refining information), and a corresponding estimate.

Interface data 160 generally includes one or more graphical user interface (GUI) components that workflow processing system 130 can present on client computer 120, based on whether a user is interacting with the complex interactive workflow (e.g., using full workflow interface components 162) or the estimation workflow (e.g., using estimation workflow interface components 164). The GUI components may include, for example, hypertext markup language (HTML) components or code that generates HTML components that can be passed to a client computer 120 and rendered as a user interface (e.g., forms, text fields, and so on). The GUI components may additionally include instructions executable by a client computer 120 to display a user interface using language-specific or operating system-specific GUI components (e.g., instructions for displaying Win32 forms or similar components on other operating system platforms, Abstract Window Toolkit or Swing API components on the Java platform, and so on). Generally, instructions capable of rendering a GUI on a client computer 120 may include computer executable code generated from compiling and/or interpreting C (or variants thereof), Java, PHP, Ruby, HTML, javascript, Python, Ajax, VBscript, and other programming or scripting languages used to compose and present a GUI. In an example tax preparation application, full workflow interface components 162 may include screens for prompting a user for personal information (e.g., name, address, social security number), income information (from W-2s, 1099s, K-1s, and so on), and various deductions and credits that the user may qualify for. In some cases, interface data 160 may include instructions for parsing data from images of various forms or other documents that include relevant data.

For an estimation interface, estimation workflow interface components 164 generally include forms and other GUI components that allow a user to input representative data points. In one example, estimation workflow interface components 164 may allow a user to provide representative data without using keyboard input and instead specify the representative data points using a series of mouse clicks or interactions with a touchscreen. Estimation workflow interface components 164 may additionally include one or more forms and other GUI components that can be used to obtain data that estimation engine 150 can use to refine the estimated results of the full interactive workflow, as well as one or more screens that can be used to display estimates of how different components in the full interactive workflow impact the estimated results of the full interactive workflow.

Session data 170 generally stores user input provided through a user interface displaying full workflow interface components 162 and/or estimation workflow interface components 164 for further processing by analysis engine 140 or estimation engine 150. As discussed above, in some cases, a user can provide data used by estimation engine 150 to refine the estimated results of the complex interactive workflow. The data provided through a user interface displaying full workflow interface components 162 may be stored in session data 170 while a user provides representative data to workflow processing system 130 in an estimation workflow. When a user requests an estimate and provides the representative data points used by estimation engine 150 to estimate the results of the complex interactive workflow based on results of the complex interactive workflow generated for similar users, estimation engine 150 can obtain session data 170 to generate a query.

Data store 180 generally is a repository storing the results of completed workflows that estimation engine 150 can use to estimate the results of a full interactive workflow. As illustrated, data store 180 generally includes one or more data tables 182, which may be a relational database that associates the results of the full interactive workflow with one or more representative data points. In some cases, data table 182 may function as a lookup table with estimated ranges of results correlated to particular representative data inputs. For example, in a tax preparation application, the lookup table may include an estimated range of results for each combination of income range, filing status, and number of dependents. In a tax preparation application, data tables 182 may associate the calculated tax refund or liability for a user to an income range, marital status, number of dependents, and so on. When estimation engine 150 receives user input of an income range, filing status, and number of dependents and queries data table 182 for estimated results of the complex, interactive workflow, estimation engine 150 may receive a range of estimates from data table 182. Estimation engine 150 does not need to calculate the range of results to display to a user (e.g., as discussed above, by performing a statistical analysis of a data set of workflow results for users with similar characteristics) and may display the data included in data table 182 for the specified representative data in estimation interface 114.

Rules database 184 generally includes rules used by analysis engine 140 to generate the results of the complex interactive workflow. For example, in a tax preparation workflow, rules database 184 can include, for example, rules defining tax brackets, income-based phase-outs of tax deductions, rules defining eligibility for various tax credits or other benefits, and so on.

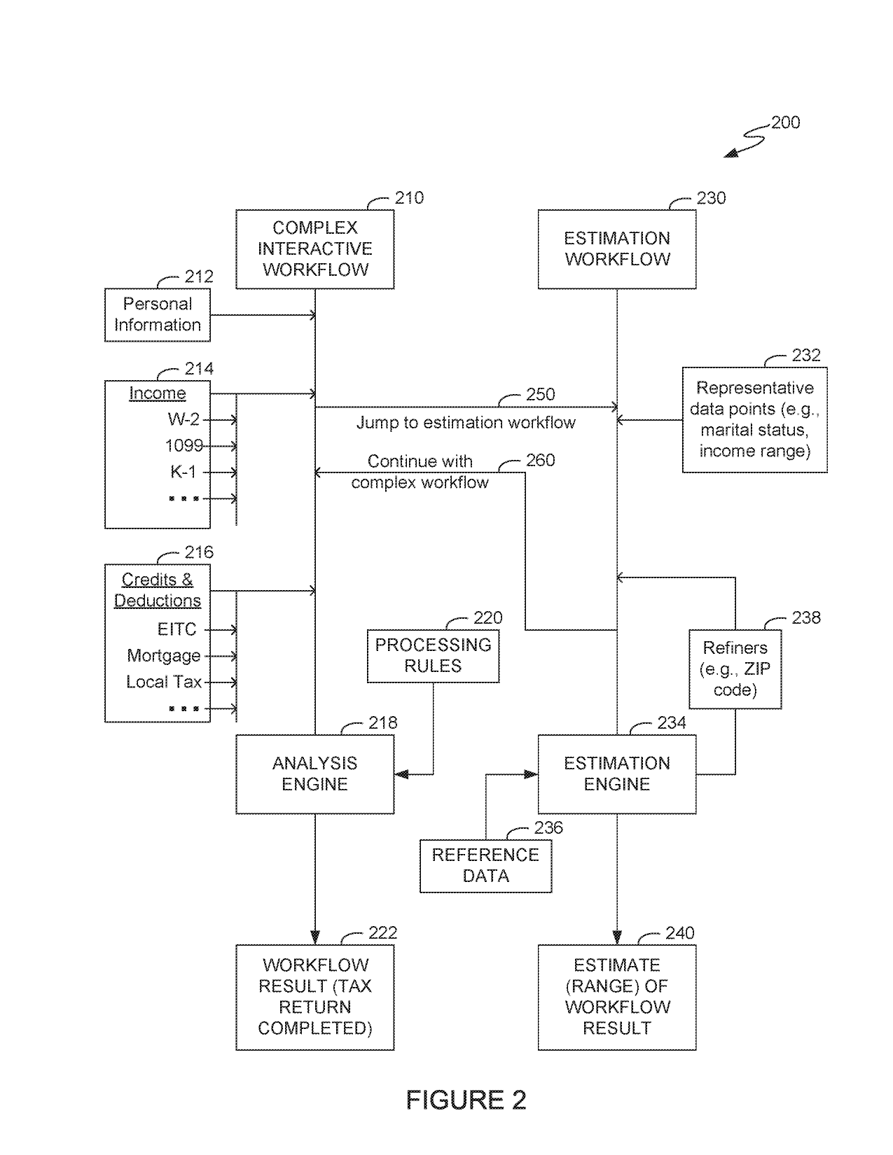

FIG. 2 illustrates an example tax preparation application 200 with a complex interactive workflow 210 and an estimation workflow 230, according to one embodiment. While the complex interactive workflow 210 and estimation workflow 230 are illustrated as running substantially in parallel, the complex interactive workflow 210 and estimation workflow 230 need not be performed concurrently or in a particular order. For example, workflow processing system 130 can present the user with an estimation interface to execute estimation workflow 230 before launching the full interactive interface to execute complex interactive workflow 210.

As illustrated, complex interactive workflow 210 generally includes steps for preparing a tax return, where a user provides personal information at step 212, income information at step 214, and credits and deduction information at step 216. Personal information generally includes, for example, data such as social security numbers for the user and any dependents the user is claiming in a tax return, the user's address, the user's marital status, and so on. After the user provides the personal information at step 212 to workflow processing system 130, the user is prompted to enter income information at step 214. Because income can be reported for a large number of different sources, the complex interactive workflow 210 may request income data in a number of different steps. For example, the complex interactive workflow 210 could request income and withholdings from wages as an initial step, and then request non-wage income (e.g., income from investments, capital gains/losses, and so on), and then income from business operations, and so on. Subsequently, the complex interactive workflow 210 proceeds to step 216 to determine whether a user is eligible for tax credits and request information used to calculate the amount of deductions that user can take against income. For example, the full interactive workflow may present one or more screens to request information relevant to determining if the user qualifies for the earned income tax credit based on previously provided data (e.g., marital status and income information). To calculate deductions that a user can take against income, the full interactive workflow may present one or more screens to request information, for example, about mortgage interest paid by the user, real estate taxes paid by the user, and so on.

After a user provides personal information, income data, and credits and deductions data to workflow processing system 130, at step 218, an analysis engine uses the data and a set of processing rules 220 to generate the workflow result 222 of a completed tax return (and an associated refund or liability amount). As discussed above, the analysis engine can generate the workflow result as a set of results for different components of the complex interactive workflow. For example, the analysis engine could first calculate a refund or liability amount based on data provided at the income stage. The analysis engine could proceed to calculate additional refund amounts associated with different credits and refund amounts associated with the total amount of deductions that a user is entitled to take. After the analysis engine generates the tax return and associated refund or liability amounts, the analysis engine can save the workflow result for the overall workflow and the different components of the workflow to a data repository for storing the results of a full interactive workflow.

In one embodiment, a user can switch from the full interactive workflow to the estimation workflow, as illustrated at arrow 250. While switching from the complex interactive workflow 210 to the estimation workflow 230 is illustrated after a user enters income information, the user may switch from the complex interactive workflow 210 to the estimation workflow 230 at any point while participating in the complex interactive workflow 210. For example, a user may switch to the estimation workflow 230 when the user is requested to provide personal information at step 212. In some cases, a user may begin with the estimation workflow 230 and switch to the complex interactive workflow 210 after completing the estimation workflow 230. Further, a user may switch from complex interactive workflow 210 to estimation workflow 230 explicitly (e.g., by clicking a button to switch from the full interactive workflow to the estimation workflow) or implicitly (e.g., by omitting input in certain fields required by the complex interactive workflow 210)

In some cases, workflow processing system 130 may switch from the full interactive workflow to the estimation workflow after a user requests to be transferred to the estimation workflow 230, or more simply, after a user requests an estimate of certain results they should expect if they complete the complex interactive workflow 210. In other cases, workflow processing system 130 may switch from the complex interactive workflow 210 to the estimation workflow 230 based on the absence of user input needed for the full interactive workflow. For example, workflow processing system 130 may switch to the estimation workflow 230 if the user does not provide income data to workflow processing system 130 at the appropriate step of the complex interactive workflow 210.

When a user switches to the estimation workflow 230, at 232, workflow processing system 130 may present an interface prompting for a set of representative data points about the user. As noted above, the representative data points are used to obtain an estimate of the results the user should expect if the user completes the complex interactive workflow 210, based on the experience of a population of users sharing the same representative data points. The representative data points may include, in a tax preparation example, marital status, income range, and a number of dependents. The requested reference points may be provided to estimation engine at step 234 to generate a query against reference data 236 to obtain the estimated range of results of complex interactive workflow 210 for users with similar characteristics as the user. As discussed above, estimation engine can, in some cases, receive a single data point from a lookup table that is associated with a set of representative data points (e.g., income range, marital status, and a number of dependents).

In some cases, as discussed above, at step 234, estimation engine can determine that the estimated results of results of the full interactive workflow could be refined by obtaining one or more pieces of additional reference data, or refiners. For example, refining information, such as a ZIP code, whether a user paid property tax during the year, whether a user paid interest on a home mortgage or student loans, and so on, may be input into estimation engine along with the reference points described above to obtain a more accurate estimate of the results of the full interactive workflow by searching for an estimate associated with a set of users that more closely matches the situation or characteristics of the user using estimation workflow 230.

After estimation workflow 230 presents an estimate about the workflow results, workflow processing system 130 may prompt the user to continue with the complex interactive workflow 210. As discussed above, if a user does continue with the complex interactive workflow 210 after receiving an estimated workflow result, workflow processing system 130 can use the data input to the estimation workflow 230 to populate or otherwise provide data to relevant portions of the complex interactive workflow 210. For example, data about a user's income, marital status, and number of dependents may be used to determine whether the user is eligible for the earned income tax credit. If the user is eligible for the earned income tax credit, workflow processing system 130 may request additional data related to the earned income tax credit in the full interactive workflow.

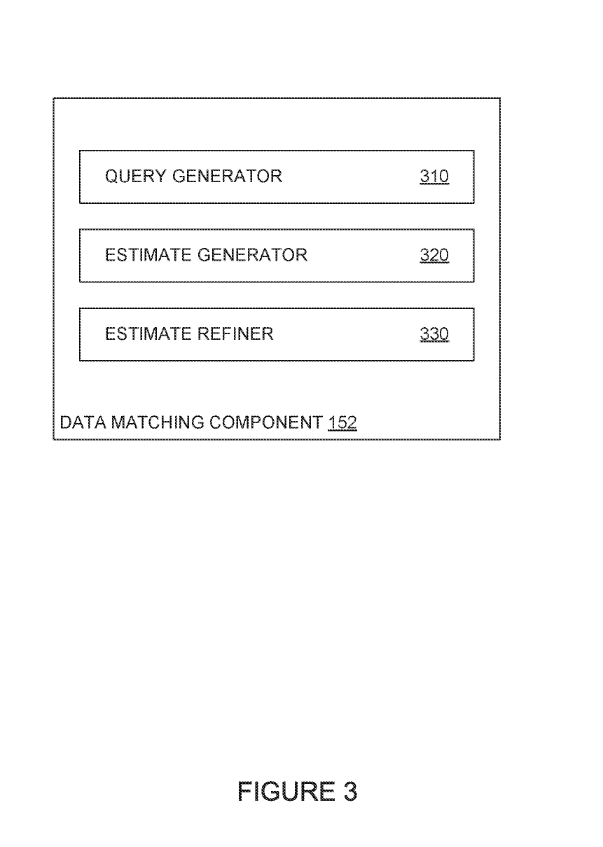

FIG. 3 illustrates an example data matching component 152, according to one embodiment. As illustrated, data matching component 152 generally includes a query generator 310, an estimate generator 320, and an estimate refiner 330.

Query generator 310 uses the representative data obtained from a user in the estimation workflow to request data from data table 182 for results of the complex interactive workflow for users with similar characteristics. For example, query generator 310 may identify, from a lookup table, an estimate of a return amount the full interactive workflow. As a user provides additional representative data points, query generator 310 may add the additional representative data points to the query to be executed on data table 182.

Estimate generator 320 generally receives, in response to executing the query generated by query generator 310 on data table 182, an entry from a lookup table including the estimated results of the complex interactive workflow associated with the one or more representative data points. Estimate generator 320 may display the estimated results to a user in an interface on client computer 120 using estimation interface components 164.

Estimate refiner 330 generally examines data points received from the data repository to determine one or more additional representative data points that can be used to increase the accuracy of the estimated range of results for the complex interactive workflow. In some cases, estimate refiner 330 can use data provided to complete interactive workflow to generate a query for a subset of the previously analyzed data.

By providing an estimate of results that a user can expect from engaging in the complex interactive workflow 210, the service provider offering the full workflow (e.g., the online tax preparation service) can encourage a user to complete the complex interactive workflow 210. Further, because the estimate is based on a statistical analysis of results obtained by similar users, the estimate provides a reasonably accurate estimate of the results of a complex interactive workflow and provides a data point that can encourage a user to use the complex interactive workflow to, for example, prepare a tax return.

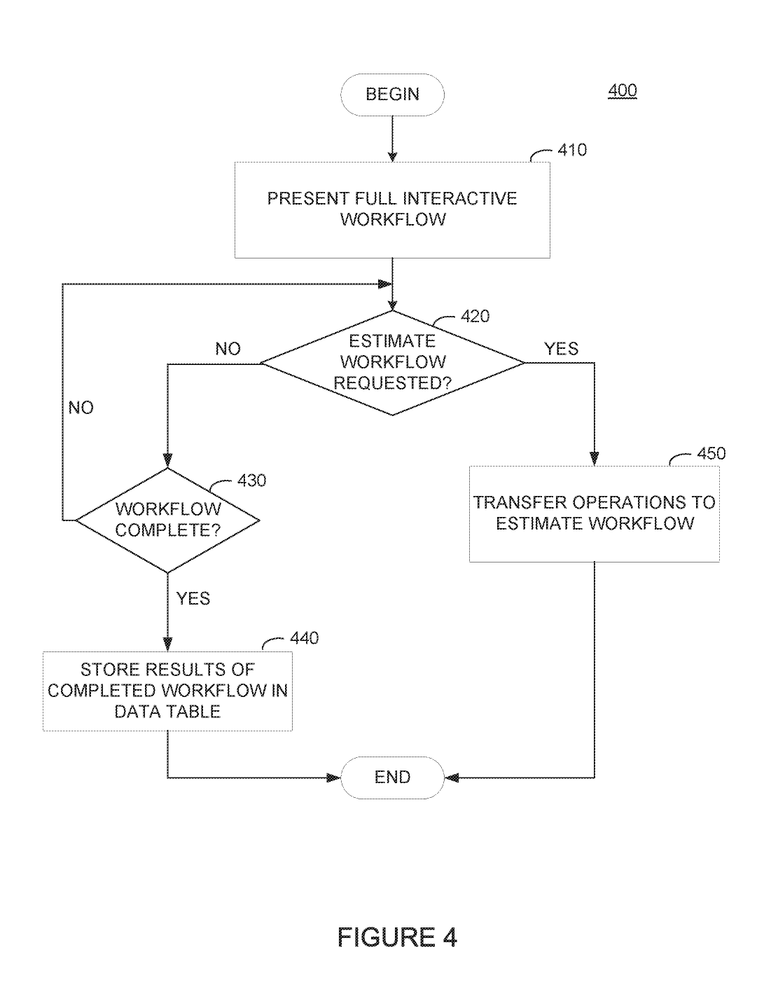

FIG. 4 illustrates example operations 400 that may be performed to switch from a full interactive workflow to an estimate workflow, according to one embodiment. As illustrated, operations 400 begin at step 410, where workflow processing system 130 presents a full interactive workflow to a user. The full interactive workflow may be displayed, for example, on a user interface 122 of client computer 120 using full workflow interface components 162.

At step 420, workflow processing system 130 determines whether an estimated result for the full workflow has been requested. A user may request to invoke the estimate workflow, for example, by clicking on a button in an interface of the complex interactive workflow to request an estimate of the results that the user should expect, should the user complete the full interactive workflow. In another case, workflow processing system 130 can determine that a user has requested an estimate for the full interactive workflow based on user inputs (or an absence of user inputs) in the full interactive workflow. For example, workflow processing system 130 can invoke the estimate workflow when a user requests a result of a tax preparation workflow but has not yet provided income data to the full workflow.

If, at step 420, workflow processing system 130 determines that a user requested an estimate (e.g., by detecting an explicit request, such as a user clicking a button to request an estimate or an implicit request, such as a user omitting information required by the full interactive workflow), then at step 450, workflow processing system 130 transfers operations to the estimate workflow. Otherwise, at step 430, workflow processing system 130 determines if the workflow is complete. If not processing system 130 presents the next interface step of the full workflow to a user and returns to step 420 to determine if the user requested an estimate workflow from the new user input screen. Otherwise once complete, workflow processing system 130 can store the results of the completed workflow.

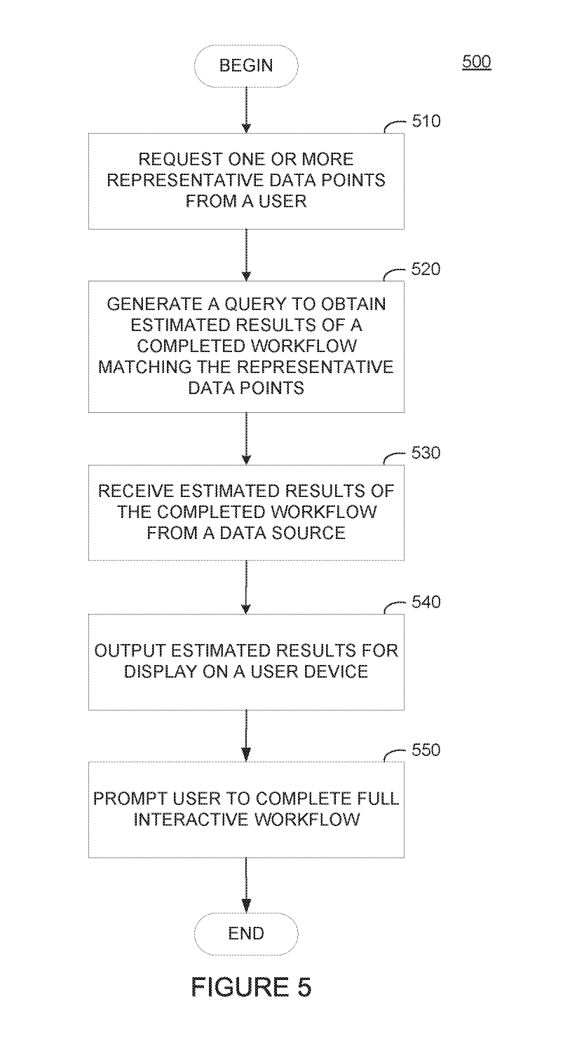

FIG. 5 illustrates example operations 500 performed to generate an estimate of the results of a complex interactive workflow based on one or more representative data points about a first user and the results of a population of users in completing the complex interactive workflow, according to one embodiment. As illustrated, operations 500 begin at step 510, where workflow processing system 130 prompts a user to provide representative data points needed to estimate the results that user should expect from completing the complex interactive workflow. For example, workflow processing system 130 may request an income range, marital status, and number of dependents as the representative data points used to determine an estimate of a tax refund amount.

At step 520, workflow processing system 130 generates a query to execute on a data source to obtain an estimate based on the representative data points. As described above, in one embodiment, an estimate may be obtained from a lookup table that correlates values of the representative data points provided by the user to an estimated result. In some cases, parameters for the lookup may be derived or inferred from the user-provided representative data points. For example, workflow processing system 130 can infer a user's filing status based on a marital status and number of dependents provided by that user (e.g., if a user is single and claims a non-zero number of dependents, workflow processing system 130 can infer that the user would file a tax return as a head of household).

At step 530, workflow processing system 130 receives the estimated results of the completed workflow (e.g., from data table 182). In some cases, if data table 182 is structured as a lookup table that associates a set of keys to an estimated result, workflow processing system 130 may receive a single data point (i.e., the estimated tax return users with a given income range, number of dependents, and marital status can expect) from the data table. In an alternative embodiment where workflow processing system 130 dynamically generates an estimated result for the complex interactive workflow, workflow processing system 130 can receive a data set of results to process into an estimated range of results.

In some cases, workflow processing system 130 can determine how different data values required for the complex interactive workflow contribute to the estimated result. For example, in a tax preparation workflow, workflow processing system 130 may generate an estimated benefit (e.g., earned income tax credit) that the user may be entitled to claim based on benefits claimed by similar users that have previously completed the full interactive workflow. For example, entries in a lookup table for estimated results of a complex interactive workflow based on prior user experience with the complex interactive workflow may include additional data that divides the calculated result into a set of components.

At step 540, workflow processing system 130 outputs the estimated results, which may be transmitted to the client system 120. In some cases, workflow processing system 130 can also display estimated ranges of how different components of the full workflow contribute to the overall estimated result of the completed workflow.

At step 550, workflow processing system may prompt the user to return to (or to initiate) the full interactive workflow. If the user proceeds to the full interactive workflow, workflow processing system 130 can use the data provided in the estimation workflow to pre-populate at least a portion of the full interactive workflow. The estimated range of results that a user can expect if the user completes the complex interactive workflow can be displayed to a user to encourage a user to commit to completing the complex interactive workflow. As discussed above, some users may be unwilling to provide some information needed by the complex interactive workflow to generate a completed result (e.g., a completed tax return) without some assurance that the results are close to what the user expects. By providing a reasonably accurate estimate of the results of a complex interactive workflow from the results of the complex interactive workflow calculated for other users, workflow processing system 130 can provide a data point that can encourage a user to use the complex interactive workflow to, for example, prepare a tax return.

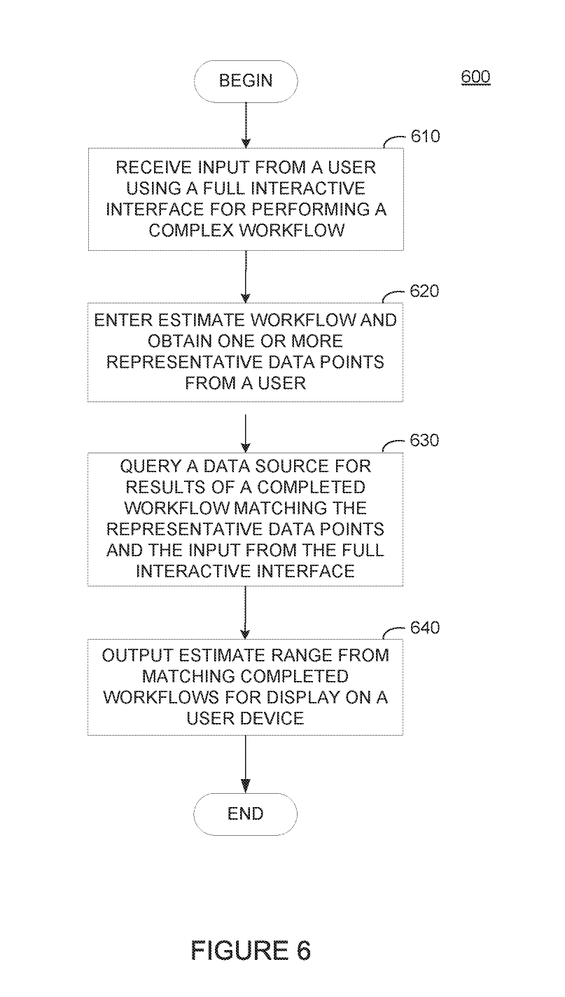

FIG. 6 illustrates example operations 600 to estimate the results of a complex interactive workflow based on representative data points and refiner data, according to an embodiment. As illustrated, operations 600 begin at step 610, where workflow processing system 130 receives input from interface components of a complex workflow. For example, as discussed above, a workflow process may begin by requesting personal information, and a user may provide some personal information, such as locality data that can be used as refiner data in a query.

At step 620, workflow processing system 130 enters an estimate workflow and obtains one or more representative data points from a user. As discussed above, workflow processing system 130 can enter an estimate workflow based on user selection of the estimate workflow or if workflow processing system 130 detects that a user did not provide certain data input (e.g., income data) that may be required to complete the complex workflow.

At step 630, workflow processing system 130 queries a data source representing a statistical analysis of the results of the completed workflow matching the representative data points and the refiner data. Using the tax preparation example discussed above, if the input from the full interactive interface includes a user's address, the query may request the previously calculated estimate range for the group of users in the same locality (e.g., ZIP code) with an income between a user-specified amount, a filing status inferred from the user's marital status and number of dependents, and the number of dependents specified by the user. At step 640, workflow processing system 130 outputs an estimate range from matching completed workflows for display on a user device.

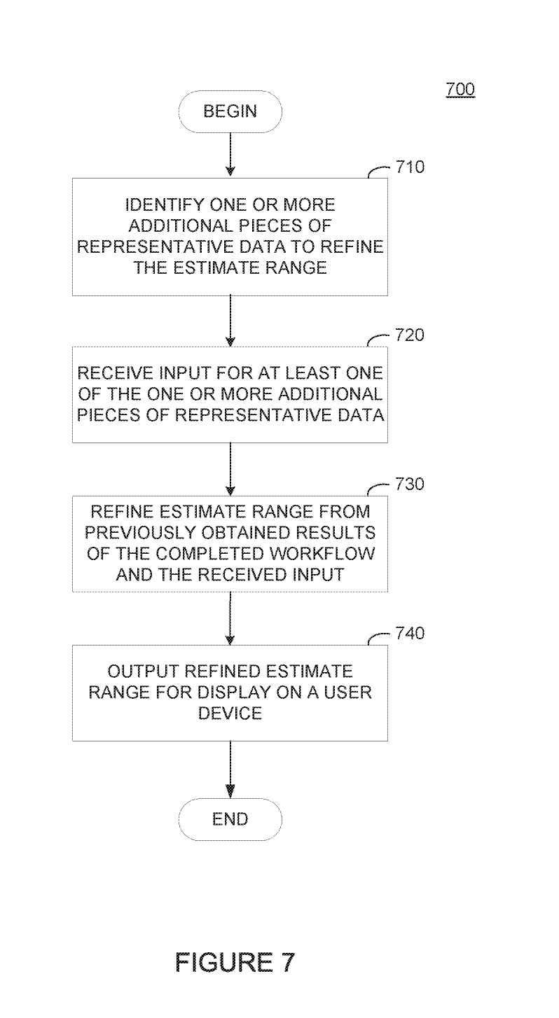

FIG. 7 illustrates example operations 700 that may be performed by workflow processing system 130 to refine a previously provided estimate using additional representative data points, according to one embodiment. As illustrated, operations 700 begin at step 710, where workflow processing system 130 identifies an additional representative data point regarding the user requesting an estimate of the complex interactive workflow, which, if known, could be used to refine the estimate for that user. For example, workflow processing system 130 can examine the data set returned by a previously executed query to find trends in the data set, such as geographical clustering or other user attributes that can influence the estimated result. In a tax preparation example, these attributes may include items such as home ownership or deductions for local taxes.

At step 720, workflow processing system 130 prompts the user to provide an additional representative data point (as identified in step 710). In one example, workflow processing system 130 can request the user's address. In response to receiving the user's address, workflow processing system 130 can narrow the data set returned from the original query and determine whether to request information about home ownership based on, for example, the address and income range previously provided by the user to estimate a range of tax refund amounts that the user should expect to receive after completing the complete tax preparation workflow.

At step 730, workflow processing system 130 refines the estimate range from the previously obtained results of the completed workflow and the received input. To refine the estimate range, workflow processing system 130 can generate a new query to look up an entry in a data table for the estimates of the completed workflow previously calculated for a group of users with similar characteristics. For example, workflow processing system 130 can obtain, from a lookup table, the estimated range of results calculated for users in a specific area who have the same or similar income, marital status, and number of dependents. In an alternative case, workflow processing system 130 can process results from data table 182 to dynamically calculate an estimate of the results of the complex interactive workflow. At step 740, workflow processing system 130 outputs the refined estimate range for display on a user device.

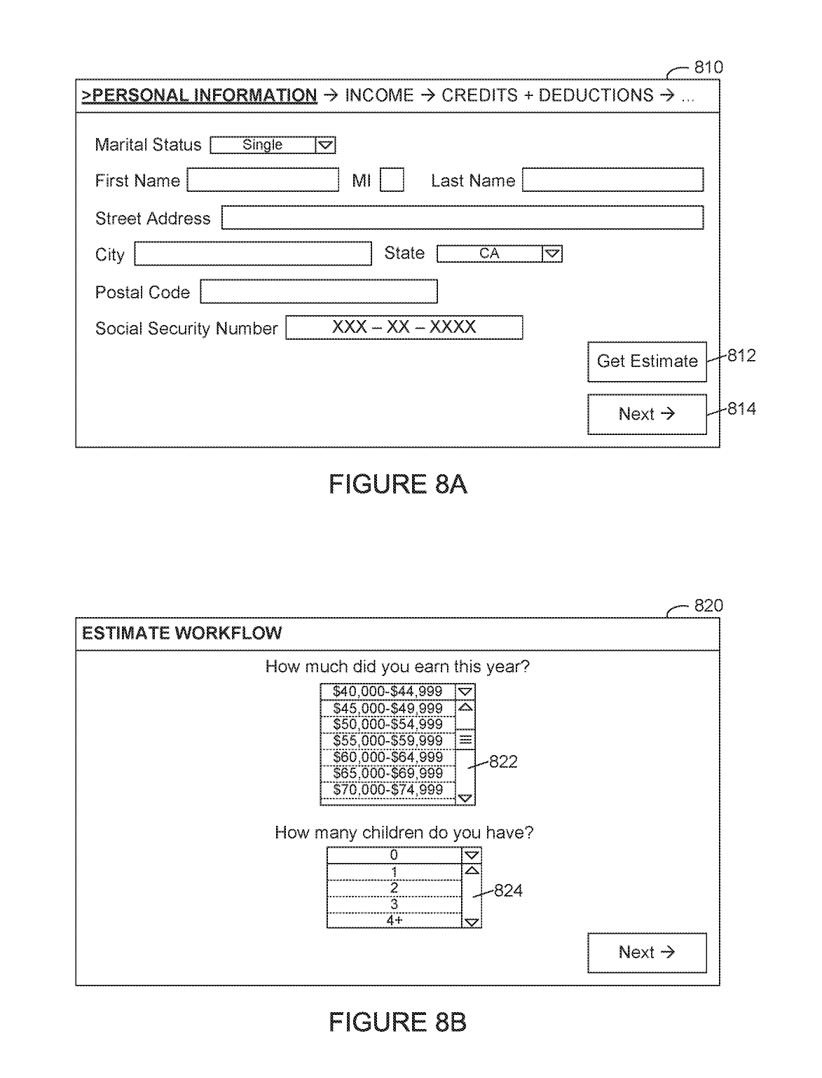

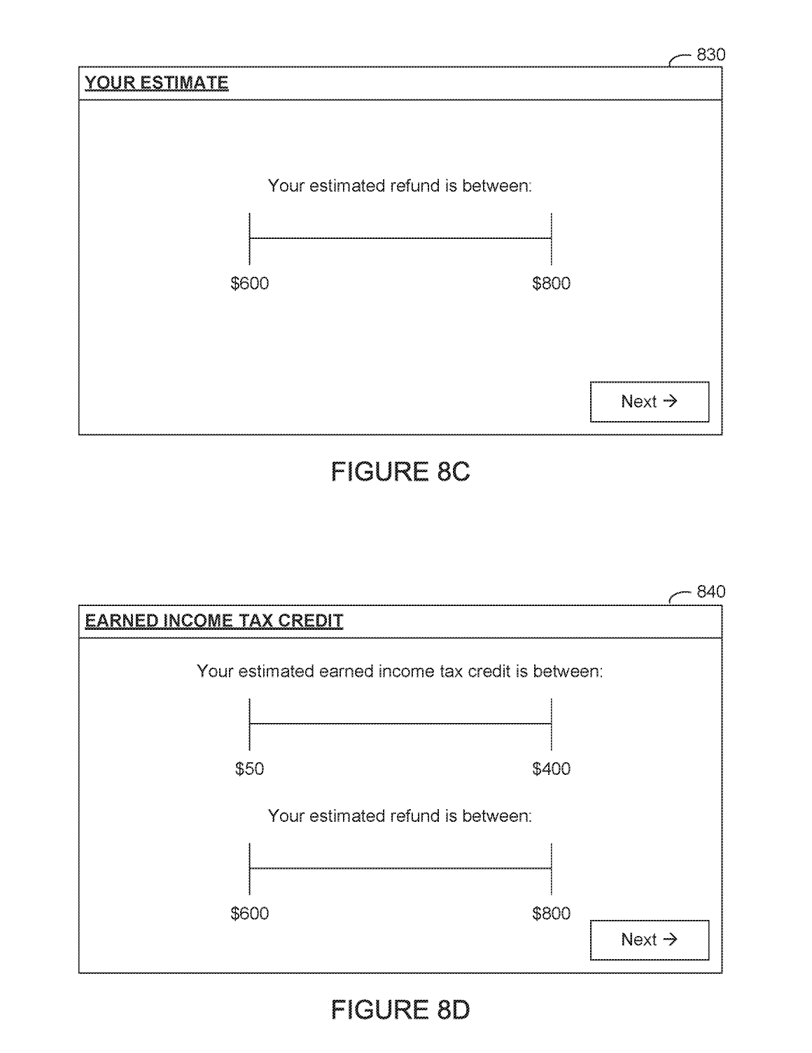

FIGS. 8A-8D illustrate an example user interface sequence that can be used in obtaining one or more pieces of representative data to generate an estimated result (or range of results) for a tax preparation workflow, according to one embodiment.

As illustrated in FIG. 8A, workflow processing system 130 can initially request personal information from a user through screen 810. The personal information generally includes, for example, marital status, an address, and a user's social security number. When a user is presented with the user interface illustrated in FIG. 8A, the user may not be willing to provide personal information to the workflow processing system or may not want to spend the time needed to provide all of the information needed to complete a complex interactive workflow without having some expectations of the results of the complex interactive workflow. In a tax preparation case, a user may wish to obtain an estimate of the workflow results before preparing a tax return with real data, which may require a few hours to complete. Thus, FIG. 8A includes two options for proceeding with the tax preparation workflow. A first button 812, labeled “Get Estimate,” launches an estimation workflow, as discussed above. A second button 814, labeled “Next,” causes workflow processing system 130 to examine the data fields in FIG. 8A to determine whether to launch an estimate workflow, continue with the full interactive workflow, or prompt the user to enter data into one or more required fields. As discussed above, workflow processing system 130 can launch an estimate workflow if, for example, a user clicks the “Next” button 814 without providing a social security number or by providing an invalid social security number.

Assume that a user is not committed to completing the complex interactive workflow or is uncomfortable providing certain personal information to workflow processing system 130 until the user has some expectation about the results of the complex interactive workflow. A user can select button 812 to launch the estimate workflow, which may begin with the screen 820 illustrated in FIG. 8B. As illustrated, screen 820 presents an interface in an estimate workflow which prompts the user to provide representative data points needed by workflow processing system 130 to generate an estimate of the results that a user should expect from completing the complex interactive workflow. As discussed above, workflow processing system 130 can, for example, present the interface illustrated in FIG. 8B after a user expressly selects the “Get Estimate” button 812 illustrated in FIG. 8A. As illustrated, FIG. 8B requests two representative data points from the user: an income range in a first drop down menu 822 and the number of children the user has in a second drop down menu 824.

FIG. 8C illustrates a screen 830 in an estimate workflow that presents the estimated results of the completed complex interactive workflow based on the representative data points provided by the user from screen 820 illustrated in FIG. 8B and knowledge about prior results of the complex interactive workflow. In the tax preparation workflow case illustrated in FIG. 8C, screen 830 estimated tax refund amount to a user based on the data provided in the interfaces shown in FIGS. 8A and 8B. As discussed above, the estimate may be generated from a statistical analysis of the results of the completed complex workflow for users with the same or substantially similar attributes (e.g., income range, filing status, number of dependents, locality, and so on). For example, the low end estimate displayed in FIG. 8C may be two standard deviations less than the average result, while the high end estimate displayed in FIG. 8C may be two standard deviations greater than the average result.

FIG. 8D illustrates a screen 840 in an estimate workflow that presents the estimated earned income tax credit benefit for a user based on an analysis of the results of the completed complex workflow for users with the same or substantially similar attributes. As illustrated, the screen 840 in FIG. 8D shows both the estimated amount of the benefit that a user can claim as well as the estimated total refund (or liability) amount displayed in FIG. 8C. While FIG. 8D illustrates displaying an estimated earned income tax credit benefit for a user, the estimation workflow can display estimates for any number of different components of a complex workflow, such as estimates of tax credits and/or, estimated deductions available for home ownership (home mortgage interest, private mortgage insurance, real estate taxes), student loan interest, and so on.

In one embodiment, the screens 830 and 840 may allow a user to resume (or initiate) the complex interactive workflow after viewing estimated results of the complex interactive workflow. If a user transitions from the estimation workflow to the full interactive workflow after workflow processing system 130 generates an estimate, workflow processing system 130 can automatically populate certain fields in the full interactive workflow based on the data provided in the estimation workflow. For example, if a user indicates during the estimation workflow that the user is single and claims a non-zero number of children, workflow processing system 130 can automatically select the user's filing status in the full interactive workflow.

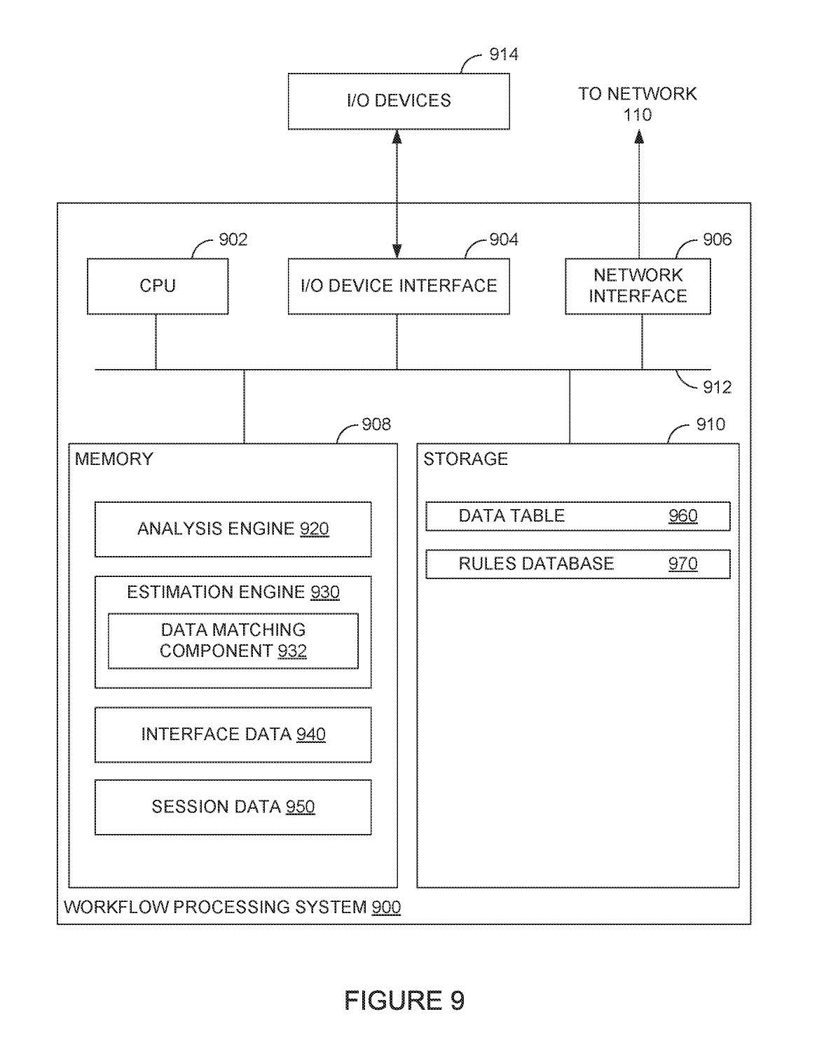

FIG. 9 illustrates an example workflow processing system used to estimate the results a given user should expect from completing the complex interactive workflow based on a set of representative data points and a statistical history of the workflow, according to an embodiment. As shown, the system 900 includes, without limitation, a central processing unit (CPU) 902, one or more I/O device interfaces 904 which may allow for the connection of various I/O devices 914 (e.g., keyboards, displays, mouse devices, pen input, etc.) to the system 900, network interface 906, a memory 908, storage 910, and an interconnect 912.

CPU 902 may retrieve and execute programming instructions stored in the memory 908. Similarly, the CPU 902 may retrieve and store application data residing in the memory 908. The interconnect 912 transmits programming instructions and application data, among the CPU 902, I/O device interface 904, network interface 906, memory 908, and storage 910. CPU 902 is included to be representative of a single CPU, multiple CPUs, a single CPU having multiple processing cores, and the like. Additionally, the memory 908 is included to be representative of a random access memory. Furthermore, the storage 910 may be a solid state or disk drive. Although shown as a single unit, the storage 910 may be a combination of fixed and/or removable storage devices, such as fixed disc drives, removable memory cards or optical storage, network attached storage (NAS), or a storage area-network (SAN). In some cases, system 900 may be a single physical system or a distributed system, such as in one or more computer systems or data centers, with processing capabilities, memory 908, and storage 910 distributed across multiple computer systems.

As shown, memory 908 includes an analysis engine 920, estimation engine 930, interface data 940, and session data 950. As discussed above, analysis engine 920 generally obtains data for a full interactive workflow and generates the results of the full interactive workflow based on the obtained data and one or more processing rules associated with the workflow. For example, analysis engine 920 used in a tax preparation workflow may include processing rules for different types of income and eligibility rules for different credits and/or deductions. Analysis engine 920 used in a motor vehicle insurance workflow may include processing rules based on age, gender, and motor vehicle make/model.

Estimation engine 930 generally obtains one or more pieces of representative data from a user and queries data table 960 for estimated results of the complex interactive workflow based for users with characteristics that match (or substantially match) the representative data provided by the user to estimation engine 930. Estimation engine 930 generally includes a data matching component 932, which may generate queries against data table 960 for results of the completed workflow from users with characteristics that match (or substantially match) the representative data provided by a user to estimation engine 930. Based on the query generated by data matching component 932, estimation engine 930 obtains an estimated range of results for the complex interactive workflow. The range of results, as discussed above, may be based on a statistical analysis of the results of other users that have prepared, for example, a tax return using the complex interactive workflow in the previous year. Further, estimation engine 930 can examine the set of results returned from data table 960 to identify one or more additional pieces of representative data that estimation engine 130 can obtain to generate a refined estimate of the results of the completed workflow.

Interface data 940 generally includes data that can be displayed while a user engages in either the full interactive workflow or the estimation workflow based on user selection and data inputs. As discussed above, interface data 940 for a full interactive interface used in a tax preparation workflow may include one or more screens that prompt a user for personal information, income information, and deduction and credit information. The data provided to workflow processing system 900 through interface data 940 for a full interactive interface may be routed to analysis engine 920 for analysis engine 920 to process and generate a result of the completed workflow. Interface data 940 for an estimation interface used in a tax preparation workflow may include one or more simplified screens that allow a user to input representative data, for example, as a set of ranges. The data provided to workflow processing system 900 through interface data 940 for an estimation interface may be routed to estimation engine 930 for estimation engine 930 to generate an estimated range of results for the completed workflow.

Session data 950 generally includes data provided to workflow processing system 900 by a user traversing through either the full interactive workflow or the estimation workflow described above. When a user submits data to workflow processing system 900, the data may be maintained in session data 950 until a user completes the full interactive workflow. Once the user completes the full interactive workflow, the session data 950 may be flushed or otherwise saved to data table 960, along with the result of the full interactive workflow, for use in generating additional estimates of the completed workflow for other users. Additionally, as discussed above, information in session data 950 may be used to refine the results generated by estimation engine 930. For example, if a user provides locality information in an initial portion of a full interactive workflow and subsequently transitions to the estimation workflow, the locality data may be used to refine or generate an initial estimate for the completed workflow.

As shown, storage 910 includes a data table 960 that generally stores the results of the completed workflow and associates each result of the completed workflow to characteristics of the user for which workflow processing system generated the result. For example, in a tax preparation workflow, data table may store statistical analyses of the calculated tax refund (or liability) amounts for users matching a set of criteria. The statistical analyses may be based, at least in part, on tax return data calculated in the previous tax year. In some cases, the statistical analyses may include a range of refund (or liability amounts) associated with a particular income range, filing status, and number of dependents. Additionally, as discussed above, additional entries in data table 960 may include statistically analyzed data for narrower sets of users that prepared tax returns using the workflow processing system 900 in the previous year, such as users in a particular ZIP code. As discussed above, results of the full interactive workflow committed to data table 960 may be anonymized such that a result stored in data table 960 does not identify personal information about any particular user. Storage 910 additionally includes rules database 970, which analysis engine 920 generally accesses to generate the results of the complex interactive workflow. For example, in a tax preparation workflow, the rules stored in rules database 970 may include information regarding tax brackets and marginal tax rates, eligibility for deductions and credits, and so on.

While the foregoing is directed to embodiments of the present disclosure, other and further embodiments of the disclosure may be devised without departing from the basic scope thereof, and the scope thereof is determined by the claims that follow.

What is claimed is:

1. A method for providing an estimate of a result of an interactive workflow, the method comprising:
receiving a request to estimate a result expected to be obtained by a first user in completing the interactive workflow;
receiving one or more representative data points characterizing the first user;
generating a query based on the representative data points;
executing the query to determine the estimate, wherein the query retrieves the estimate from a database storing estimates generated from an analysis of results of the interactive workflow obtained by a population of users sharing the representative data points characterizing the first user; and
providing, based on the executed query, the estimate of the result expected to be obtained by a first user in completing the interactive workflow.

2. The method of claim 1, wherein receiving the request to estimate the result expected to be obtained by the first user comprises:
detecting, based on input provided to the interactive workflow, a request to estimate the result; and
switching from an interface of the interactive workflow to an interface of a second workflow.

3. The method of claim 2, wherein receiving the request to estimate the result expected to be obtained by the first user comprises inferring the request based on an absence of input for a data field in the interactive workflow.

4. The method of claim 1, wherein executing the query comprises:
searching for the estimate of the result in a lookup table, wherein the one or more representative data points provides a key value for a corresponding entry in the lookup table and wherein the corresponding entry includes the estimate of the result.

5. The method of claim 4, wherein the key value includes a data point inferred from a first one of the representative data points.

6. The method of claim 1, wherein providing the estimate of the result expected to be obtained by the first user comprises:
determining a range of results from the results of the interactive workflow obtained by a plurality of second users; and
calculating the estimate based on the determined range of results.

7. The method of claim 1, further comprising:
determining at least one additional representative data point to request from the first user to refine the estimated result; and
determining a second estimate of the result related to the interactive workflow expected to be obtained by the first user based on the one or more representative data points characterizing the first user, the at least one additional representative data point, and an analysis of the results of the interactive workflow obtained by the plurality of the second users sharing the one or more representative data points and the at least one additional representative data point with the first user.

8. The method of claim 1, wherein receiving the one or more representative data points comprises:
receiving a first one of the representative data points from the interactive workflow; and
receiving at least a second one of the representative data points from a second workflow.

9. The method of claim 1, wherein the estimate comprises an aggregation of results for one or more components of the interactive workflow.

10. A computer-readable medium comprising instructions, which, when executed by a processor, performs an operation for providing an estimate of a result of an interactive workflow, the operation comprising:
receiving a request to estimate a result expected to be obtained by a first user in completing the interactive workflow;
receiving one or more representative data points characterizing the first user;
generating a query based on the representative data points;
executing the query to determine the estimate, wherein the query retrieves the estimate from a database storing estimates generated from an analysis of results of the interactive workflow obtained by a population of users sharing the representative data points characterizing the first user; and
providing, based on the executed query, the estimate of the result expected to be obtained by a first user in completing the interactive workflow.

11. The computer-readable medium of claim 10, wherein receiving the request to estimate the result expected to be obtained by the first user comprises:
detecting, based on input provided to the interactive workflow, a request to estimate the result; and
switching from an interface of the interactive workflow to an interface of a second workflow.

12. The computer-readable medium of claim 11, wherein receiving the request to estimate the result expected to be obtained by the first user comprises detecting an absence of input for a data field in the interactive workflow.

13. The computer-readable medium of claim 10, wherein executing the query comprises:
searching for the estimate of the result in a lookup table, wherein the one or more representative data points provides a key value for a corresponding entry in the lookup table and wherein the corresponding entry includes the estimate of the result.

14. The computer-readable medium of claim 13, wherein the key value includes a data point inferred from a first one of the representative data points.

15. The computer-readable medium of claim 10, wherein providing the estimate of the result expected to be obtained by the first user comprises:
determining a range of results from the results of the interactive workflow obtained by the plurality of second users; and
calculating the estimate based on the determined range of results.

16. The computer-readable medium of claim 10, wherein the operations further comprise:
determining at least one additional representative data point to request from the first user to refine the estimated result; and
determining a second estimate of the result related to the interactive workflow expected to be obtained by the first user based on the one or more representative data points characterizing the first user, the at least one additional representative data point, and an analysis of the results of the interactive workflow obtained by the plurality of the second users sharing the one or more representative data points and the at least one additional representative data point with the first user.

17. The computer-readable medium of claim 10, wherein receiving the one or more representative data points comprises:
receiving a first representative data point about the first user from the interactive workflow; and
receiving at least a second representative data point about the first user from a second workflow.

18. The computer-readable medium of claim 10, wherein the estimate comprises an aggregation of results for one or more components of the interactive workflow.

19. A system, comprising:
a processor; and
a memory storing instructions, which, when executed by the processor, perform an operation for providing an estimate of a result of an interactive workflow, the operation comprising:
receiving a request to estimate a result expected to be obtained by a first user in completing the interactive workflow;
receiving one or more representative data points characterizing the first user;
generating a query based on the representative data points;
executing the query to determine the estimate, wherein the query retrieves the estimate from a database storing estimates generated from an analysis of results of the interactive workflow obtained by a population of users sharing the representative data points characterizing the first user; and
providing, based on the executed query, the estimate of the result expected to be obtained by a first user in completing the interactive workflow.

20. The system of claim 19, wherein receiving the request to estimate the result expected to be obtained by the first user comprises:
detecting, based on input provided to the interactive workflow, a request to estimate the result; and
switching from an interface of the interactive workflow to an interface of a second workflow.

21. The system of claim 20, wherein receiving the request to estimate the result expected to be obtained by the first user comprises detecting an absence of input for a data field in the interactive workflow.

22. The system of claim 19, wherein executing the query comprises:
searching for the estimate of the result in a lookup table, wherein the one or more representative data points provides a key value for a corresponding entry in the lookup table and wherein the corresponding entry includes the estimate of the result.

23. The system of claim 22, wherein the key value includes a data point inferred from a first one of the representative data points.

24. The system of claim 19, wherein providing the estimate of the result expected to be obtained by the first user comprises:
determining a range of results from the results of the interactive workflow obtained by the plurality of second users; and
calculating the estimate based on the determined range of results.

25. The system of claim 19, wherein the operations further comprise:
determining at least one additional representative data point to request from the first user to refine the estimated result; and
determining a second estimate of the result related to the interactive workflow expected to be obtained by the first user based on the one or more representative data points characterizing the first user, the at least one additional representative data point, and an analysis of the results of the interactive workflow obtained by the plurality of the second users sharing the one or more representative data points and the at least one additional representative data point with the first user.

26. The system of claim 19, wherein receiving the one or more representative data points comprises:
receiving a first representative data point about the first user from the interactive workflow; and
receiving at least a second representative data point about the first user from a second workflow.

27. The system of claim 19, wherein the estimate comprises an aggregation of results for one or more components of the interactive workflow.
